(19) United States
(12) Patent Application Publication
(10) Pub. No.: US 2008/0197654 A1
(43) Pub. Date: Aug. 21, 2008

(54) FORWARD MOUNTED POWER DRIVE ASSEMBLY

(75) Inventors: Steven P. Livesey, Walled Lake, MI (US); Ganesh Ramaseshadri, Ypsilanti, MI (US); Sylvester Prusik, Philadelphia, PA (US)

Correspondence Address: DICKINSON WRIGHT PLLC, 1901 L. STREET NW, SUITE 800, WASHINGTON, DC, 20036, US

(73) Assignee: Johnson Controls Technology Company, Holland, MI (US)

(21) Appl. No.: 11/949,512

(22) Filed: Dec. 3, 2007

Related U.S. Application Data
(60) Provisional application No. 60/872,752, filed on Dec. 4, 2006.

(51) Int. Cl. B60N 2/06; A47C 1/00

(52) U.S. Cl. 296/65.13; 297/344.11

(57) ABSTRACT

An adjustable vehicle seat assembly having a track system and a drive system for power adjustment of the seat position within a vehicle.

### CROSS REFERENCE TO RELATED APPLICATIONS

This application claims the benefit of U.S. Provisional Application No. 60/872,752, filed Dec. 4, 2006, the entire disclosure of the provisional application being considered part of the disclosure of this application and hereby incorporated by reference.

### BACKGROUND OF THE INVENTION

1. Technical Field

The present invention relates generally to the field of adjustable vehicle seat assemblies. More particularly, the present invention relates to the field of track systems for use in adjustable vehicle seat assemblies.

2. Discussion

Vehicle seat assemblies are typically provided with a track system that enables the position of the seat assembly within a motor vehicle to be adjusted in the forward and rearward direction. Such adjustment capability is desirable to enable vehicle operators of various size to be seated comfortably within the motor vehicle. Such seat assemblies can be manual adjustment assemblies or power adjustment assemblies, and typically include two or more tracks that move relative to one another. In manual adjustment assemblies, a latching mechanism releasably retains the tracks (and therefore the seat assembly) in a locked position relative to one another until the latch mechanism is released. Once the latch mechanism is released, the tracks can be moved relative to one another, which allows the occupant of the seat assembly to adjust the position of the seat assembly and then to re-engage or release the latching mechanism to hold the seat in the new position. In such configuration, the latch mechanism pins may break or deform, thereby rendering the seat positioning track system difficult to use or inoperative.

Power adjustment vehicle seat assemblies include an electric motor coupled to a lead screw positioned within the track assembly in place of the latching mechanism in manual adjustment assemblies. In such arrangement, the lead screw is fixed to a track coupled to the seat and does not rotate but a worm gear assembly coupled to the lead screw and fixedly attached to a track coupled to the vehicle structure and the electric motor causes the worm gear to translate along the fixed non-rotating lead screw to move the vehicle seat assembly forward or rearward. In such configuration, the electric motor, mounted on a traverse beam is positioned at approximately the center of each of the tracks. Therefore, while the lead screw is rotationally fixed, the track including the lead screw transitions along one direction relative to the electric motor and the vehicle. Such configurations, including the electric motor, take up additional space under the seat assembly which inhibits routing of cables and ducts associated with equipment in the vehicle. The electric motor fixed to the vehicle also limits clearance beneath a seat for the feet of an occupant in the rear seats of the vehicle.

Thus there is a need for a vehicle seat track system that will provide increased floor clearance beneath the seat assembly. There is also a need for a track system for a vehicle seat that meets or exceeds the established strength, speed, noise requirements. There is a further need to provide a reliable, acceptable seat track system for providing translational adjustment, which avoids one or more of the above referenced and other problems.

### SUMMARY OF THE INVENTION

One embodiment of the invention relates to a track system for a vehicle seat having a seat base and a seat back. The track system includes first track and second track sets that each include a lower rail coupled to the vehicle and an upper rail coupled to the seat and slidingly coupled to the lower rail, lead screws mounted between the upper and lower rails, transmissions rotatably coupled to the lead screws, a traverse rail coupled to the upper rails, and a motor coupled to the traverse rail having a vertical offset from the two track sets, and rotatably coupled to each of the transmissions. The rotation of the lead screws moves the seat from a first position to a second position along the first and second track sets. The track system may also include flexible drive cables coupled to the motor and transmission. The flexible drive cables may be equal in length. The track system may also include a fixed nut bracket, proximate the transmission and coupled to the lead screw and lower rail.

Another embodiment of the invention relates to a seat for a vehicle. The seat for a vehicle includes a seat back, a seat base that is coupled to the seat back, and a track system. The track system includes first track and second track sets that each include a lower rail coupled to the vehicle and an upper rail coupled to the seat and slidingly coupled to the lower rail, lead screws mounted between the upper and lower rails, transmissions rotatably coupled to the lead screws, a traverse rail coupled to the upper rails, and a motor coupled to the traverse rail a vertical offset from the two track sets, and rotatably coupled to each of the transmissions. The rotation of the lead screws moves the seat from a first position to a second position along the first and second track sets. The track system may also include flexible drive cables coupled to the motor and transmission. The flexible drive cables may be equal in length. The track system may also include a fixed nut bracket, proximate the transmission and coupled to the lead screw and lower rail.

Another embodiment of the present invention relates to a motion transfer assembly that transfers rotation of the lead screw into motion along a selected axis. The motion transfer assembly includes first track and second track sets that each include a lower rail coupled to the vehicle and an upper rail coupled to the seat and slidingly coupled to the lower rail, lead screws mounted between the upper and lower rails. The nut bracket may include a nut concentrically restrained to movement along the axes, one of which is the translational (i.e., forward and rearward) direction relative to the vehicle.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a perspective view of a vehicle with a seat;

FIG. 2 is a perspective view of a seat for a vehicle with a track system according to an exemplary embodiment;

FIG. 3 is a perspective view of the track system in FIG. 2 in a first position;

FIG. 4 is a front elevation view of the track system in FIG. 3;

FIG. 5 is a perspective exploded view of a portion of the track assembly in FIG. 3;

FIG. 6 is a perspective exploded view of the lead screw and nut assembly;

FIG. 7 is a section view of the track system in FIG. 3 taken along line 7-7;

FIG. 8 is a perspective exploded view of a nut assembly according to one exemplary embodiment;

FIG. 9 is a perspective exploded view of a nut assembly according to another exemplary embodiment;

FIG. 10 is a cross-section of the nut assembly in FIG. 9;

FIG. 11 is a perspective exploded view of a nut assembly according to another exemplary embodiment; and

FIG. 12 is a cross-section of the nut assembly in FIG. 11.

### DETAILED DESCRIPTION OF THE PREFERRED EMBODIMENT

Before providing the description of the exemplary and alternative embodiments of the track system, it should be noted that references to “front,” “back,” “rear,” “upper,” and “lower” in this description are merely used to identify the various elements as they are oriented in the FIGURES, with “front,” “back,” and “rear” being relative the direction of travel of the vehicle in which the track system is placed. These terms are not meant to limit the element which they describe, as the various elements may be oriented differently in various track systems.

For purposes of this disclosure, the term “coupled” means the joining of two members directly or indirectly to one another. Such joining may be stationary in nature or moveable in nature and/or such joining may allow for the flow of fluids, electricity, electrical signals, or other types of signals or communication between the two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

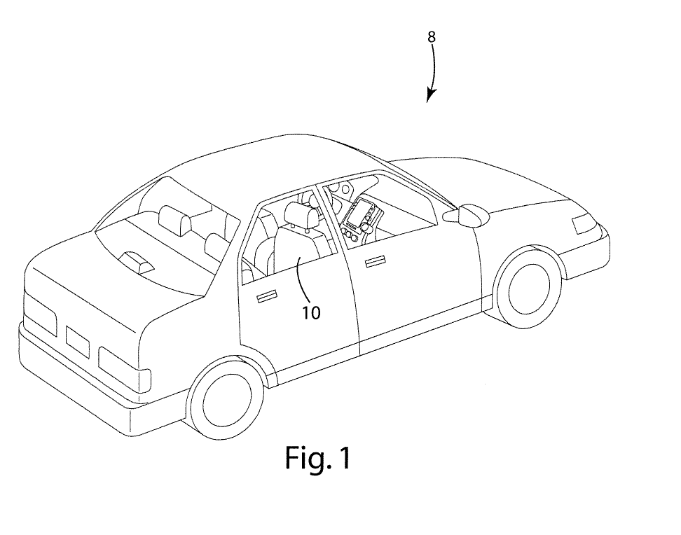

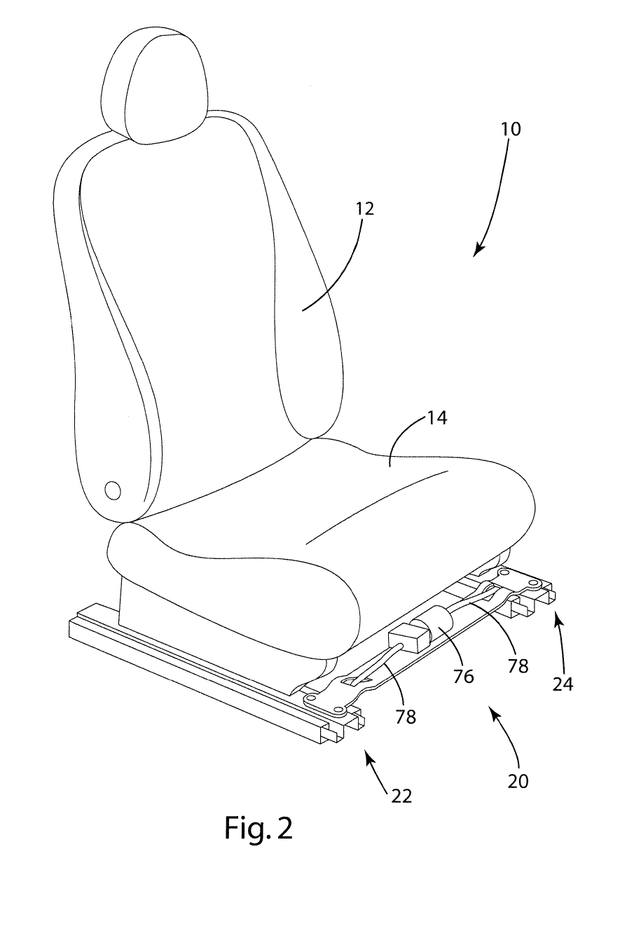

Referring to FIG. 1, a vehicle 8 having a vehicle seat 10 is shown according to an exemplary embodiment. As further illustrated in FIG. 2, the seat 10 includes a generally vertical seat back or back portion 12 and a generally horizontal seat base or seat cushion portion 14. Seat 10 is coupled to a track system 20 that is configured to allow an occupant to adjust the position of the seat 10 in the translational (i.e., forward and rearward) direction relative to the vehicle.

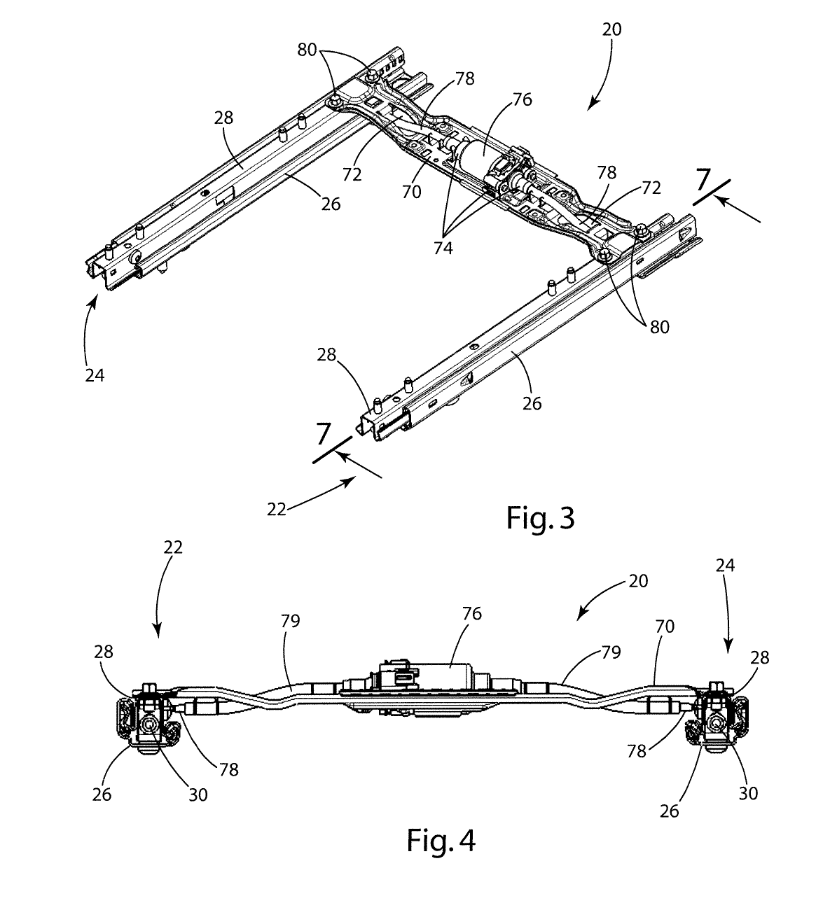

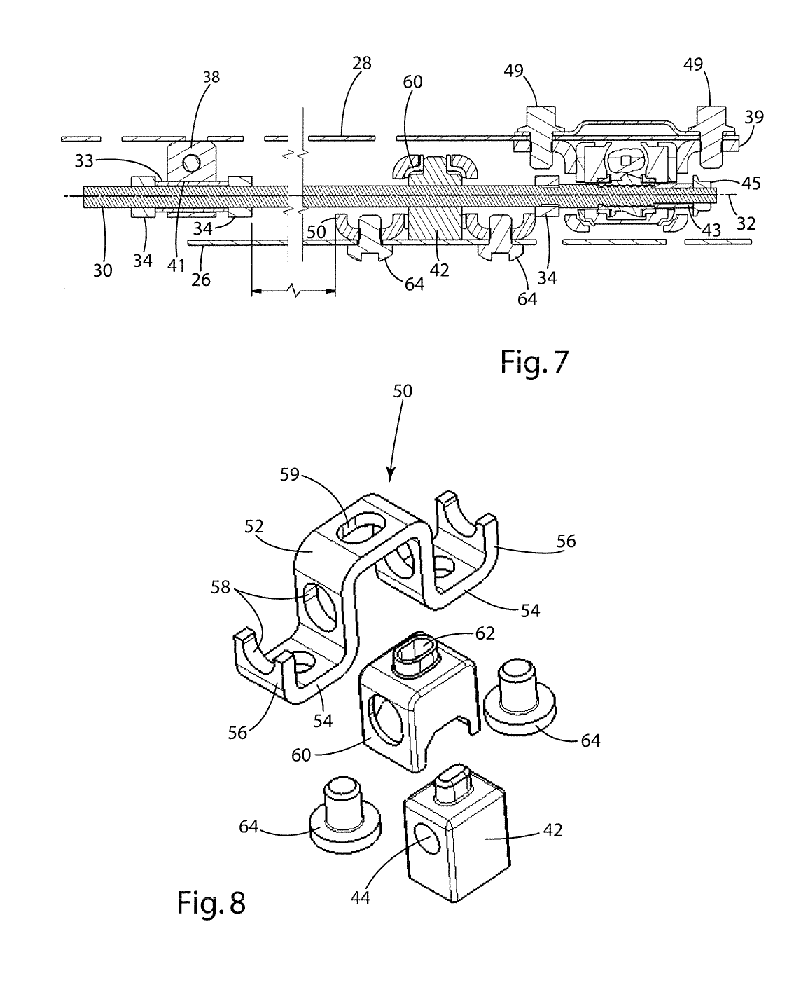

Referring to FIGS. 3-7, the track system 20 is shown in more detail. Track system 20 includes a first track set 22, a second track set 24 that is generally parallel to the first track set 22, and traverse rail 70 that is generally perpendicular to the first track set 22 and the second track set 24. The first track set 22 and second track set 24 each include a lower rail 26 (e.g., first rail, fixed rail, frame rail, etc.) that is coupled to a structure such as a the floor of a vehicle and an upper rail 28 (e.g., second rail, moveable rail, seat rail, etc.) that is coupled to the seat 10 and is slidably coupled to the lower rail 26. The traverse rail 70 is coupled to the upper rails 28 with fasteners 80 and translates with the upper rails 28 when the seat 10 is moved in a translational direction relative to the vehicle.

Referring to the FIGURES and according to one exemplary embodiment, the upper rail and the lower rail are shown with a particular cross sectional shape with the upper rail substantially surrounded by the lower rail. It should be understood that it is not meant that the track system should be limited to this particular design and that any arrangement of upper and lower tracks are acceptable where a first rail is slidably coupled to a second rail such that a lead screw may be coupled to both the upper rail and the lower rail. According to other various alternative and exemplary embodiments, the size, shape, and configurations of the upper rail and the lower rail may vary depending on one or more of a plurality of different factors, including the application in which the tracks system will be used, the environment in which the tracks system will be used, the size of the lead screw, cost considerations, manufacturing considerations, etc.

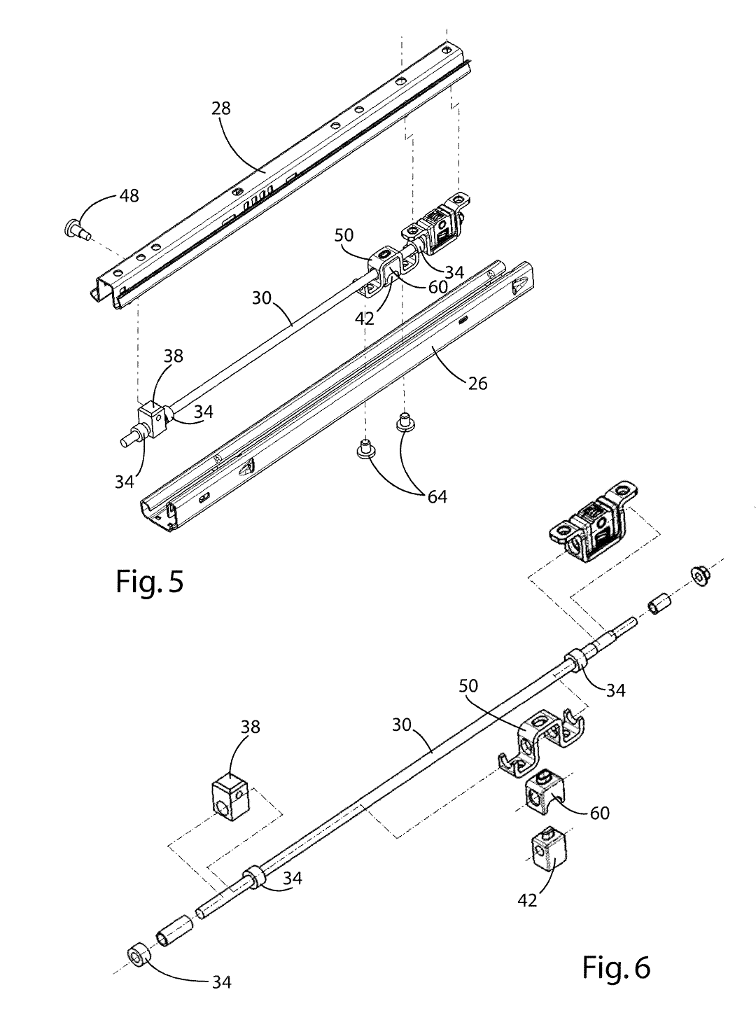

Referring now especially to FIGS. 5-7, track system 20 further includes lead screws 30 (e.g. threaded members, etc.) with longitudinal axis 32 that are generally parallel with the first track set 22 and the second track set 24. Each of the lead screws 30 are between an upper rail 28 and lower rail 26 and coupled to upper rail 28 and lower rail 26 with a bracket 38 (e.g. end bracket, etc.), a transmission 40 and a nut 42 (e.g., fixed nut, threaded member, etc.). The transmission 40 is coupled to the upper rail 28 with for example a bracket 39 and fastener 49. End bracket 38 and transmission 40 are provided on opposite ends of the lead screw 30. End bracket 38 is coupled to the upper rail 28 with fasteners 48, (e.g., bolts, screws, rivets, etc.). The lead screw 30 is rotatably coupled to the end bracket 38 such that it is free to rotate in an aperture 41 (e.g., hole, passage, socket, etc.) defined by the end bracket 38. A bushing 33 may be coupled to the end bracket 38 to suppress noise. Lead screw 30 may also include retaining members 34 (e.g., crimp collars, flanges, stops, etc.) that prevent lead screw 30 from translating along longitudinal axis 32 relative to end bracket 38 and transmission 40. The transmission 40 can be coupled to lead screw with engaging members such as a sleeve 43 and collar nut 45 or the like (e.g., splines, teeth, ridges, a key etc.).

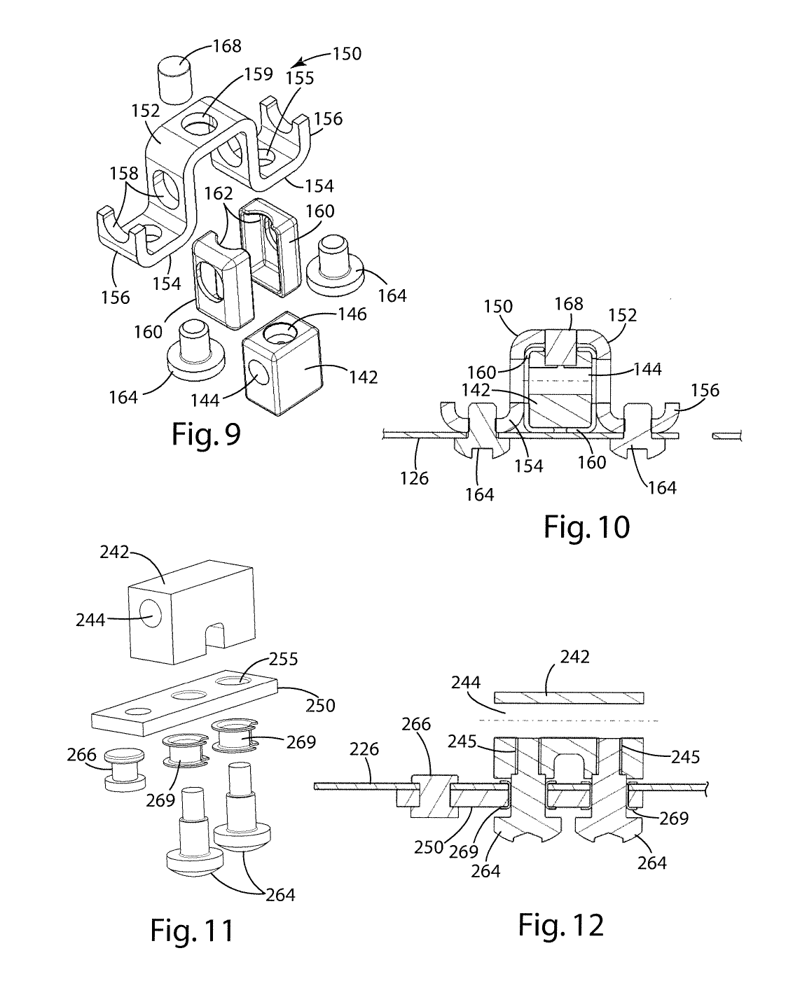

Referring to FIG. 8 a nut assembly is shown according to one exemplary embodiment. The nut 42 is provided between the transmission 40 and end bracket 38 on each lead screw 30. Nut 42 has a threaded aperture 44 that is configured to engage threads on the lead screw 30. Nut 42 is coupled to the lower rail 26 with an isolating member 60, a bracket 50 (e.g., nut bracket, retaining member, etc.), and fasteners 64. An isolating member 60 (e.g., isolator, sleeve, cover, cage, etc.) may also be coupled to the lower rail 26, nut 42 and nut bracket 50. The isolating member 60 is illustrated in FIG. 8 as at least partially surrounding the nut 42, however, the isolating member 60 may also substantially surround the nut 42, for example as illustrated in FIGS. 9 and 10 as element 160. According to an exemplary embodiment, the isolating member 60 is rubber. The isolating member 60 can be composed of any material having characteristics, i.e., strength, resiliency, etc., suitable for the intended purpose. According to one exemplary embodiment, nut bracket 50 is a generally W-shaped, thin-walled body that includes a central portion 52, two outwardly extending flanges 54 and two upwardly extending portions 56. Openings 58 (e.g. cutouts, holes, gaps, apertures, etc.) are provided in central portion 52 and upwardly extending portions 56 for lead screw 30. According to an exemplary embodiment, upwardly extending portions 56 extend upward less than the height of central portion 52 so that the openings 58 on the upwardly extending portions 56 are generally semi-circular cut-outs. According to other exemplary embodiments, the upwardly extending portions 56 may extend more or less and the openings 58 on the upwardly extending portions 56 may be holes or may be absent altogether. Flanges 54 includes holes 55 that are configured to receive fasteners 64. Fasteners 64 extend through holes in the lower rail 26 and engage the nut bracket 50 to couple the nut bracket 50 to the lower rail 26. According to one exemplary embodiment, the holes 55 in flanges 54 are threaded and engage corresponding threads on the fasteners 64. According to other exemplary embodiments, the holes 55 may not be threaded and the fasteners may be rivets or any other suitable fastener. The nut bracket 50 may also include an opening 59 configured to cooperate with a corresponding projection 62 (e.g., rim, wall, collar, etc.) on isolating member 60 and a corresponding projection 46 (e.g., boss, protrusion, bump, etc.) on nut 42 to locate the nut 42 to receive the lead screw 30.

Referring now especially to FIGS. 3 and 4, the traverse rail 70 is coupled to the upper rails 28 of first track set 22 and second track set 24 with fasteners 80. A motor 76 is coupled to the top surface traverse rail 70 and may be vertically offset from the first and second track set. In one exemplary embodiment, the motor 76 is offset 15 mm, vertically, from the transmission 40 drive axis 32. Two drive cables 78 extend outward from motor 76 in generally opposite directions in a cable housing 79 and through openings 72 in the traverse rail 70. The cable housing 79 facilitates noise suppression and guide the drive cable 78. The drive cables 78 engage the transmissions 40 such that power from the motor 76 is transmitted through the drive cables 78 to the transmissions 40. According to an exemplary embodiment, the motor 76 is located generally centered on the traverse rail 70 and the two drive cables 78 are approximately equal in length. According to other exemplary embodiments, the motor 76 may be located offset on the traverse rail 70 and one of the drive cables 78 may be longer than the other. Insulating members 74 may be provided to electrically and mechanically insulate motor 76 from the other components of the track system 20. The traverse rail 70 is configured such that the motor 76 is located proximate to the front of the seat base 14 and elevated from the floor of the vehicle to increase the amount of space under the seat 10.

The motor 76 turns the drive cables 78 which, in turn engage the transmissions 40. The transmissions 40 transmit the power from the drive cables 78 to the lead screws 30. With the lead screw 30 threadably coupled to a nut 42, when the lead screw 30 turns, the lead screw 30 moves along longitudinal axis 32 relative to the nut 42 and lower rail 26. Retaining members 34, sleeve 43, collar nut 45, bracket 39, bracket 38 and transmission 40 cause the upper rail 28 to move with the lead screw 30. In this way, the upper rail 28 and seat 10 move relative to the lower rail 26, the nut 42 and the vehicle when the motor 76 provides power to turn the lead screws 30. The seat 10 may be moved in the opposite direction by reversing the direction that the motor 76 turns. Seat 10 is moveable between a first position in which the bracket 38 is proximate to the nut 42 (e.g., a forward position, an extended position, etc.) and a second position in which the transmission 40 is proximate to the nut 42 (e.g., a backward position, a retracted position, etc.).

Referring now to FIGS. 9 and 10, a nut assembly is shown according to another exemplary embodiment. The nut 142 has a threaded aperture 144 that is configured to engage threads on the lead screw 30. Nut 142 is coupled to the lower rail 126 with a bracket 150 (e.g., nut bracket, retaining member, etc.), a locating member 168 and fasteners 164. An isolating member 160 (e.g., isolators, sleeves, covers, cages, etc.) may be coupled to the nut 142 and bracket 150 to isolate vibrations from the lead screw 30 and nut 142. The isolating members 160 are generally symmetrical and are configured to at least partially surround the nut 142. According to an exemplary embodiment, isolating members 160 are rubber. According to one exemplary embodiment, bracket 150 is a generally W-shaped, thin-walled body that includes a central portion 152, two outwardly extending flanges 154 and two upwardly extending portions 156. Openings 158 (e.g. cutouts, holes, gaps, apertures, etc.) are provided in central portion 152 and upwardly extending portions 156 configured to receive the lead screw 30. According to an exemplary embodiment, upwardly extending portions 156 extend upward less than the height of central portion 152 so that the openings 158 on the upwardly extending portions 156 are generally semi-circular cut-outs. According to other exemplary embodiments, the upwardly extending portions 156 may extend more or less and the openings 158 on the upwardly extending portions 156 may be holes or may be absent altogether. Flanges 154 includes holes 155 that are configured to receive fasteners 164. Fasteners 164 extend through holes in the lower rail 126 and engage the bracket 138 to couple the bracket 138 to the lower rail 126. According to one exemplary embodiment, holes 155 in flanges 154 are threaded and engage corresponding threads on the fasteners 164. According to other exemplary embodiments, the holes 155 may not be threaded and the fasteners may be rivets or any other suitable fastener. The bracket 150 also includes an opening 159 configured to cooperate with corresponding openings 162 (e.g., cutouts, holes, gaps, apertures, etc.) in isolating members 160 and a corresponding recessed area 146 (e.g., depression, hollow, etc.) on the nut 142 to receive a locating member 168 (e.g., locator, pin, rod, boss). According to an exemplary embodiment, the locating member 168 is a generally cylindrical member made of nylon.

Referring now to FIGS. 11 and 12, a nut assembly is shown according to another exemplary embodiment. The nut 242 has a threaded aperture 244 that is configured to engage threads on the lead screw 30. Nut 242 is coupled to the lower rail 226 with a strap or plate 250 and fasteners 264. The plate 250 is placed on the opposite side of the lower rail 226 from the nut 242 and may be held in place with a fastener, shown as rivet 266. Fasteners 264 are threaded fasteners and extend through holes 255 in the plate 250 and corresponding holes in the lower rail 226 and engage threaded holes 245 in the nut 242. Bushings 269 may be provided between the fasteners 264 and the holes 255 in the plate 250 and the holes in the lower rail 226. This embodiments allows the nut 242 to have limited movement in a direction other than the translational direction and reduces vibration as the seat is moved as well as may allow for greater manufacturing tolerances in the lead screw. Although FIGS. 11 and 12 show a double fastener 264 design, the nut 242 could easily be coupled to the lower rail 226 with a single fastener 264. The rivet 266 also shown in FIGS. 11 and 12 may in some embodiments be removed, thereby allowing the plate 250 to be shortened.

It is important to note that the construction and arrangement of the track system as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present invention. The order or sequence of any process or method steps may be varied or re-sequenced according to alternative embodiments. Other substitutions, modifications, changes and omissions may be made in the design, operating conditions and arrangement of the various exemplary embodiments without departing from the scope of the present invention as defined by the following claims.

What is claimed is:

1. A seat assembly comprising:
a first track set and a second track set wherein each of said track sets include a first rail slidably coupled to a second rail and a lead screw having a longitudinal axis and wherein each of said lead screws are substantially constrained to rotational movement relative to one of said first and second rails on each of said first and second track sets;
a transmission coupled to each of said first and second track sets, said transmission being configured to rotate said lead screw; and
a threaded member being coupled to each of said lead screws and being configured to move along said longitudinal axis relative to said transmission as said transmission rotates said lead screw.

2. The seat assembly of claim 1 wherein said first rails are coupled to a seat and a traverse rail and wherein said seat and said traverse rail move with said first rail relative to said second rail.

3. The seat assembly of claim 1 wherein said first rails are coupled to a traverse rail and said transmission, traverse rail and said first rail move relative to said second rail.

4. The seat assembly of claim 1 further including a bracket coupling said threaded member to said second rail for moving said second rail with said threaded member.

5. The seat assembly of claim 4 further including an isolating member disposed between said bracket and said threaded member.

6. The seat assembly of claim 4 wherein said transmission is fixedly coupled to said first rail and said first rail is fixedly coupled to a seat.

7. The seat assembly of claim 4 wherein said bracket includes at least one aperture through which said lead screw passes and at least one additional opening for supporting said lead screw, said opening being disposed a distance from said threaded member.

8. The seat assembly of claim 4 wherein said threaded member includes at least one threaded hole and said bracket is a plate coupled to said second rail and wherein a fastener extending through said plate and second rail is threadably fastened to said threaded hole.

9. The seat assembly of claim 8 wherein said fastener includes a head, a shank portion, a shoulder and a threaded portion and wherein when said fastener is coupled to said threaded member with said shoulder engaging said threaded member, said shank is of a length configured to allow movement of said threaded member in a direction approximately perpendicular to said longitudinal axis.

10. The seat assembly of claim 9 further including at least one bushing disposed between said shank and said bracket and said second rail.

11. The seat assembly of claim 8 further including a fastener securely coupling said bracket to said second rail, said bracket being fastened by said fastener to prevent movement of said bracket relative to said second rail.

12. The seat assembly of claim 4 further including an isolating member disposed between said bracket and said threaded member and wherein said isolating member includes apertures for receiving said lead screw.

13. The seat assembly of claim 4 further including a locating member engaging said bracket and said first rail.

14. The seat assembly of claim 1 further including an end bracket disposed approximately on the opposite end said lead screw from said transmission and wherein said threaded member moves along said lead screw between said end bracket and said transmission as said lead screw is rotated by said transmission.

15. The seat assembly of claim 1 wherein said threaded member further includes a locating member engaging an aperture on a bracket and wherein said bracket constrains said threaded member from movement relative to said second rail.

16. A seat assembly comprising:
a first and second track set each including an upper rail attached to a seat and a lower rail, said upper and lower rails being slidably coupled;
a transition rail extending between and coupled to move with said upper rails and seat;
a drive assembly coupled to said transition rail;
a transmission and lead screw coupled to each of said first and second track sets and wherein said lead screw includes a longitudinal axis and said transmission and lead screw are coupled to move along said longitudinal axis with said upper rail relative to said lower rail and wherein said transmission translates rotational movement from the drive assembly to rotational movement of said lead screw;
a threaded member coupled to said lower rail and wherein said threaded member is configured to move along said longitudinal axis of said lead screw and relative to said transmission and said upper rail; and
a bracket coupling said threaded member from movement relative to said lower rail.

17. The seat assembly of claim 16 wherein said bracket includes apertures for receiving said lead screw and further includes at least one support opening disposed a distance from said apertures for supporting said lead screw.

18. The seat assembly of claim 16 further including an isolating member disposed between said threaded member and said bracket.

19. The seat assembly of claim 16 wherein said bracket is coupled to said lower rail with a plurality of fasteners and wherein said fasteners allow limited movement of said bracket relative to said lower rail in a direction approximately perpendicular to said longitudinal axis.

20. A seat assembly comprising:
a first and second track set each including a first rail and a second rail, said first and second rails being slidably coupled;
a transition rail extending between said first and second track sets and directly coupled to said first rail;
a drive assembly coupled to said transition rail, said drive assembly including a pair of transmissions located proximate to the intersection of said transition rail and said first and second track set;
a first lead screw coupled to said first track set and rotationally coupled to one of said transmissions, and a second lead screw coupled to said second track set and rotationally coupled to the other of said transmissions, each of said lead screws having a longitudinal axis and wherein each of said lead screws is coupled from movement along said longitudinal axis relative to one of said first rail and said second rail on each of said first and second track sets and wherein each of said first and second lead screws are coupled to a threaded member, said threaded member configured to move along said longitudinal axis as said lead screws rotate;
a bracket coupled to each of said threaded members and wherein said bracket is also coupled to one of said first and second lead screw to limit movement of the bracket and threaded member relative to said one of said first and second rails along said longitudinal axis; and
an isolating member disposed between said threaded member and said bracket.
